(19) United States
(12) Patent Application Publication
(10) Pub. No.: US 2002/0154120 A1
(43) Pub. Date: Oct. 24, 2002

(54) Annotation and application control of general purpose computer documents using annotation peripheral

(76) Inventors: Ian H.S. Cullimore, Leominster (GB); Mike L. Wood, Hereford (GB); James C. Dovey, Leominster (GB)

Correspondence Address: Otto O. Lee, Esq., Intellectual Property Law Group, Suite 1212, 12 South First Street, San Jose, CA, 95113, US

(21) Appl. No.: 09/841,586

(22) Filed: Apr. 23, 2001

(51) Int. Cl. G06T 11/20

(52) U.S. Cl. 345/441

(57) ABSTRACT

This invention relates to an annotation method for a computer. In particular, the invention relates to the method and software for a computer peripheral device to be used as an input device to electronically annotate and otherwise mark up computer documents and files such as word processing documents, graphics images, electronic mail messages, presentation documents, spreadsheets, and the like. This invention also performs application navigation functions under the control of the peripheral.

### CROSS-REFERENCE

An incorporation by reference is made to Applicants' nonprovisional application Ser. No. 09/295,159 filed Apr. 20, 1999, entitled “Sketch-Based Computer Peripheral Device”, currently pending (attorney docket number INFORMAL.PT1), which is not admitted to be prior art with respect to the present invention by its mention in the background.

### BACKGROUND

This invention relates to an annotation method for a computer. More specifically, the invention relates to the method and software for a computer peripheral device to be used as a device to electronically annotate and otherwise mark up computer documents and files such as word processing documents, graphics images, electronic mail messages, presentation documents, spreadsheets, and the like, while also performing application navigation functions under the control of the peripheral.

Users of computers sometimes have the need to annotate and mark up electronic documents on the computer. These electronic documents would perhaps be word processing documents, spreadsheet documents, presentation documents, electronic mail messages, or the like. Such annotation and marking up is generally difficult to accomplish with the current computer input/output techniques.

A mouse is difficult to use as a drawing and writing device. The mouse is bulky and cumbersome for such drawing, and the hand-eye coordination is poor since the user has to look at the screen to see what has been drawn, and not at the hand, which is doing the drawing. A graphics pad, which uses a digitizing pad and a stylus, is easier, but is still difficult, as the user cannot see the trace of what has been drawn on the digitizing pad. The user also cannot see a rendition of the document on the graphics pad or other data that is being marked up or annotated.

Other pen-like input devices that read specialized marks on paper or are pressure sensitive can be used to enter handwriting into computer systems, but this still does not work well for annotation of existing computer documents, as the user still does not have an image of the document on which to write.

The prior art contains methods for allowing handwriting annotations to be entered into computer documents. For example, tablet computers allow stylus and handwriting input and integration of the handwriting with documents that are supported by the computer system. However, this defines a special purpose system not usable with existing computer hardware; it requires a new computer system and a new operating system.

It is also often difficult or impossible to annotate existing electronic documents because the computer operating system is not equipped to allow the input or storage of such annotations, or the application employed by the user is not designed to input and store such annotations. This means the user may have to invest in expensive, special purpose devices to enable annotation of electronic documents.

There are also many software packages available for handheld personal computers (PC's) and personal digital assistant (PDA) handheld devices that allow the user to create handwritten documents on the handheld device using a stylus. Such notations can be created on the handheld device, but the only method for communicating them to the computer is via a copying operation that transfers an entire document, thereby precluding any interaction with an existing document on the computer.

Accordingly, to mark up or annotate a document on a computer, users often have to resort to printing out the document onto hardcopy paper, and then using a conventional pen or pencil or other well-known means to manually mark up or annotate the document or other data. While such a method is easy and natural, the user is now left with a non-electronic rendition of the original document, along with the mark ups or annotations, which is now very much less easily manipulated and otherwise worked with in an electronic fashion. For instance, it is not possible to directly (e.g., without first scanning in the hardcopy document) send the marked up or annotated document by electronic mail.

The prior art does not allow using annotation peripheral device and associated software to effect integration of handwritten annotation directly into computer documents regardless of the facility of the document application to allow the input or storage of such annotations. Annotation is not made more natural to perform than with a mouse, and prior art annotation devices do not have a naturalistic appearance. They do not provide visual feedback of the document being annotated so there is a shift of attention to a document image on a display separate from the surface being annotated.

Many of the examples in the prior art involve complete hardware and software implementations of document application plus annotation handling, and are special-cases, not general cases, of annotation of computer documents, inapplicable to a very large number of document types and computer applications now in use.

The prior art does not enable utilizing existing handheld devices such as Palm, Inc.'s Palm handheld devices with existing standard software to integrate handwritten annotation with conventional electronic documents.

While the prior art in limited cases allows specific manner of adding annotations to existing documents as part of a particularized feature set, there is no provision in those cases for interfacing to a commonly available peripheral annotation device to make annotation naturalistic and effective.

### SUMMARY OF THE INVENTION

Therefore the current invention provides innovation and improvements to this prior art in many ways.

The invention provides for using an annotation peripheral device and associated software to effect integration of handwritten annotation directly into computer documents regardless of the facility of the document application to allow the input or storage of such annotations. The annotation peripheral is such that annotation is more natural to perform than with a mouse, and has a naturalistic appearance. The annotation peripheral provides visual feedback of the document being annotated so there is no shift of attention to a document image on a display separate from the surface being annotated.

The invention enables utilizing existing handheld devices such as the Palm models of personal digital assistants, and existing standard software with, in order to integrate handwritten annotation with existing standard documents, when used according to the methods described in the invention and with the software embodiments of the invention.

For example, the invention is an improvement on the prior art of adding graphics to word processing documents such as Microsoft Corporation's Microsoft Word in that a common handheld device, or any device similar in possessing a touch screen and a liquid crystal display (LCD), can be used to integrate the annotations much more easily and naturally using handwriting instead of a mouse, or other pen-based input method.

The event handling and coordinate mapping defined as part of the method of the invention described in this application allow the inclusion of naturalistic handwritten annotation into most, if not all, common documents in most, if not all, personal computer and workstation computer operating environments.

As a natural outcome of using such annotation peripheral as described here, inclusion of the facility to control the computer and associated application enhances the usefulness and utility of the invention. Control of the application from the annotation peripheral is integrated in such a way that no other special software or hardware is needed, that is, the control functions are included in the capabilities of the annotation peripheral, via hardware buttons or on-screen menu selections. The capability of controlling the computer using a standard device such as a PDA, which together with the software of the invention constitute the preferred embodiment, is a significant improvement over prior art.

Therefore, this invention is way for a user to electronically annotate an electronic file via a computer. The method includes a computer system which has a computer display and an input device. Through this input device, a drawn line trace is received as input from a user. This then renders pixels which correspond to the drawn line trace according to a pre-selected attribute. The pixels are then displayed on a computer display substantially at the same time the user enters the drawn line trace through the input device.

In a preferred embodiment of the present invention, the input device is a handheld computer peripheral device. In another preferred embodiment of the present invention, the input device is a computer display. In yet another preferred embodiment of the present invention, the input device is adapted to display a selected portion of screen data displayed on the computer display. In addition, the handheld computer peripheral device may be modified to display all of the screen data displayed on the computer display.

Another embodiment of the present invention comprises adding an interpolation of the drawn line trace before rendering the pixels. This would mean the peripheral device would send only a subset of information about the drawn line trace to the computer, causing the resulting pixels on the computer display to appear as a continuous drawn line trace.

Another embodiment further comprises a step of determining one or more attributes of the drawn line trace. These attribute may include: the thickness of the drawn line trace, one or more shading characteristics, one or more dithering characteristics; a mode to erase the previously drawn line trace, and one or more colors of the drawn line trace.

In another embodiment, only an abstract representation of the drawn line trace is received. This abstract representation includes one or more of the followings: straight lines, rough-drawn straight lines, simple geometrical curves, complex geometrical curves, and composite geometrical shapes.

In addition, the abstract representation may contain information to imitate the drawn line trace. This representation includes an abstract primitive of the drawn line trace and one or more relevant attributes of the abstract primitive, sufficient to enable a recreation of the drawn line trace. A further embodiment of the abstract includes the abstract primitive of the drawn line trace, the length of the locus of the drawn line trace, the average width of the line which comprises the drawn locus of the drawn line trace, information on the color of the drawn line trace, and information to indicate the sketchy nature of the drawn line trace. Locus is defined as a set of pixels representing the drawn line trace. Abstract primitive refers to an abstract line trace information of the drawn line trace, such as a wavelength of the underlying averaged periodic sine wave corresponding to the drawn line trace.

This invention may also be implemented through a computer program product stored on a computer-readable medium for interacting with a user that inputs a drawn line trace. This product includes instruction operations for a programmable processor to receive a drawn line trace as input from a user via an input device. The processor then renders pixels which correspond to the drawn line trace according to a pre-selected attribute. The pixels are then displayed on a computer display substantially at the same time the user enters the drawn line trace through the input device.

Another embodiment uses a computer program on a computer-readable medium. The computer program includes instructions for a computer to receive a drawn line trace as input from a user via an input device. The program then renders pixels which correspond to the drawn line trace according to a pre-selected attribute. The pixels are then displayed on a computer display substantially at the same time the user enters the drawn line trace through the input device.

A further embodiment uses a computer system for a user to electronically annotate electronic files. The computer system includes a computer display and an input device. Through this input device, a drawn line trace is received as input from a user. A computer processor connected to the input device then renders pixels which correspond to the drawn line trace according to a pre-selected attribute. The pixels are then displayed on a computer display substantially at the same time the user enters the drawn line trace through the input device.

### DESCRIPTION OF DRAWINGS

FIG. 1 shows a block diagram of the complete system of the invention;

FIGS. 2A-B show a pseudocode description of how annotation data is handled and directed to the application;

FIG. 3 shows a flowchart showing how annotation data is handled and directed correctly to the application;

FIGS. 4A-B show a pseudocode description of how screen contents are refreshed on the annotation peripheral;

FIG. 5 shows a flowchart showing how the screen contents are refreshed on the annotation peripheral; and

FIG. 6 shows a flowchart showing a more intelligent downloading of information, where a check is conducted to see if a foreground and/or background information is needed to be downloaded.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

The invention provides for using an annotation peripheral (such as a Personal Digital Assistant device running 3Com, Inc.'s Palm OS, or that running Microsoft Corporation's Windows CE) as the input/output method for entering annotations into an electronic file documents via a stylus, while simultaneously viewing portions of the document via a display on the writing surface, and while using the peripheral for controlling the computer operating system where the document is stored and operated on, and the application that directly manipulates the document's data. Such electronic file may be a computer document such as a word processing document (e.g., Microsoft Word document), a spreadsheet document, (e.g., Microsoft Excel document), and a presentation document (e.g., Microsoft Powerpoint document). Possible application of the present invention includes digital signature, online collaboration of document creation and editing via the Internet, presentation of electronically annotated documents, and annotation of electronic mail documents.

The annotation peripheral is connected to a personal computer (PC). The PC may be a computer running a Microsoft Windows operating system (e.g., Windows 98, Windows 2000, Windows NT, Windows ME), or it may be a computer running a Apple Macintosh operating system. In accordance with the invention, drawing data is received by the PC from the annotation peripheral in which the position of the drawing stylus is defined in terms of the graphical coordinate space of the annotation peripheral. The received data is passed to a “Target Interface Module” which contains data describing the graphical coordinate space of the document in the target application (which we define as being the application program which is manipulating the data and display of the document of interest, the active document) and also contains instructions that define how to integrate the drawn data with the application window contents and document contents.

Simultaneously, the drawn data is passed to a “Real-time Rendering Module” which defines where on the user's display the drawn data is to be presented, and a rendition of the user's input is recreated in real time on the computer display.

The “Target Interface Module” performs coordinate translation of the drawn data according to the position of the document view in the active application, and uses facilities of the operating system and application to cause the drawing data to be imported into the document data, and formatted according to the conventions of the application. In an enabling and preferred embodiment, drawing data is converted into parameter structures defined by the “Object Linking and Embedding (OLE) Automation Interface” of the Microsoft Windows operating system to communicate with many of the most popular applications for that operating system. These OLE Automation functions are called to communicate the drawing data to the application where the data is converted into the format used internally by the application and integrated by the application into the document data.

The target application is also under the independent control of the user, and in order for the target interface module to perform coordinate mapping and to synchronize with certain states of the application, the invention also specifies an “Event Hook Module” where behavior of the target application is monitored and application user interface actions such as scrolling and moving the application window are intercepted and analyzed. The document window coordinates, and the various states of the target application and the display are communicated to the target interface module.

The invention calls for an annotation peripheral that is also a display device in the manner of a Preferred Annotation Peripheral (see above), where the annotation peripheral displays an image of the document being displayed by the target application simultaneously as the user draws or sketches annotations. According to the invention, a portion of the active document is contained within a cursor area defined by the software of the invention. When an annotation is input on the annotation peripheral it appears within the cursor area. Conversely, the image of the document within the cursor area is transmitted to the annotation peripheral for display. This is a significant improvement over the prior art which uses graphics tablets, or pen-and-paper based technology extended to computer use, as the image of the document being annotated appears on the drawing surface where the user is working. An important function of the current invention is synchronizing between the target application and the annotation peripheral such that when the image of the document within the cursor area changes, the image of the document within the cursor area is obtained and transferred to the annotation peripheral where it is displayed.

The invention also calls for the annotation peripheral, together with the software of the invention, to provide control functions to the target application that include scrolling, panning the cursor area to select different areas of the active document, zooming the active document display, and panning the active document display. These examples are illustrative and not limiting.

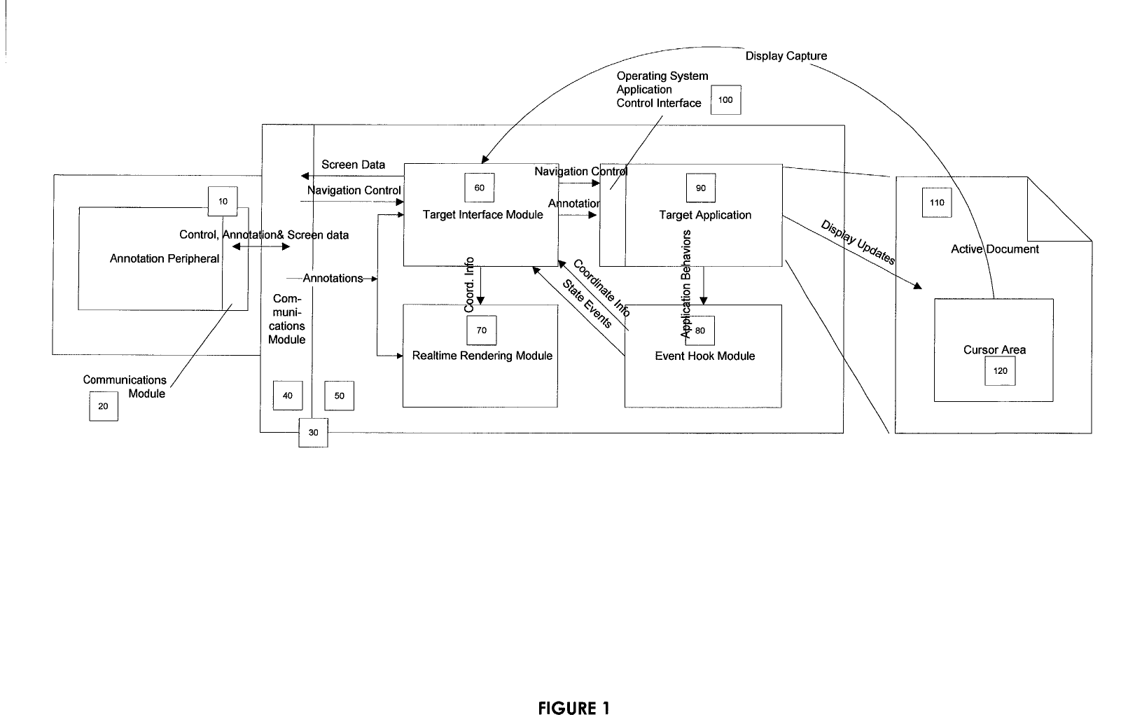

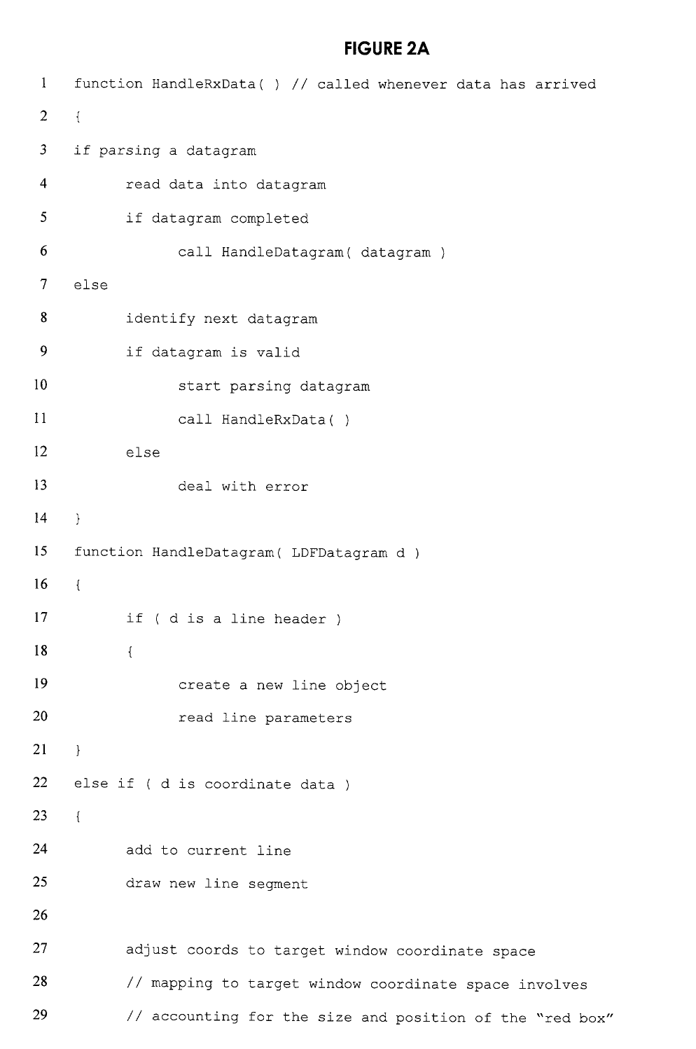

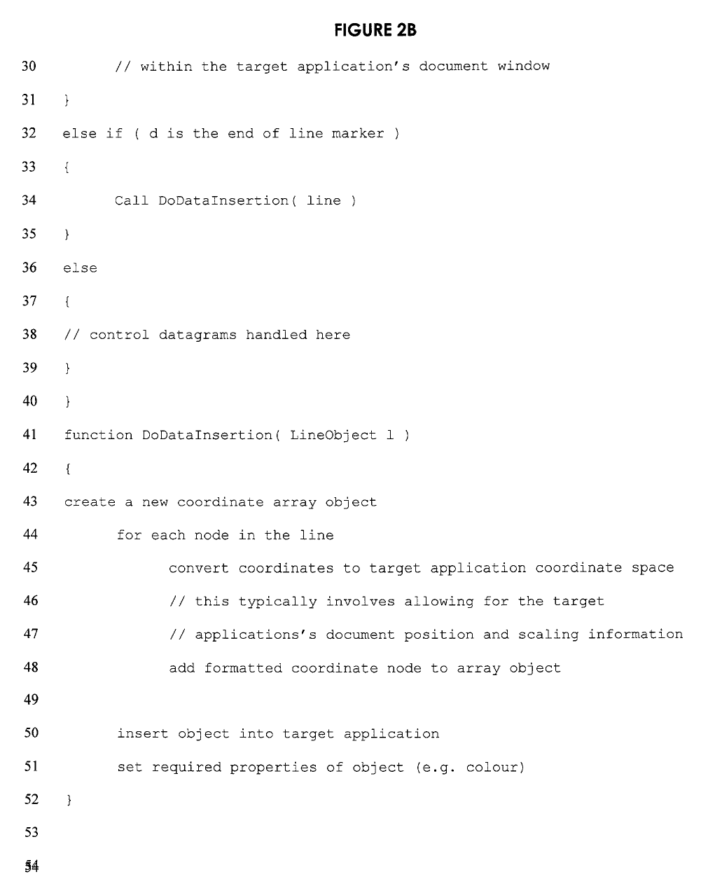

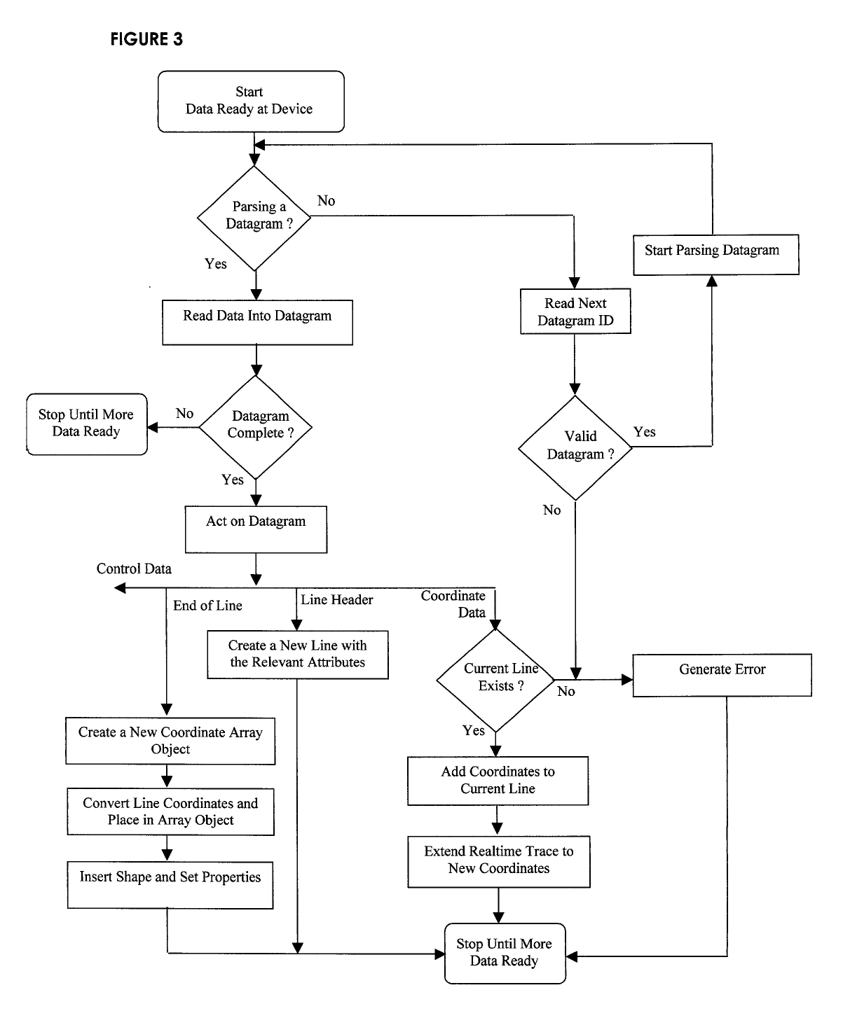

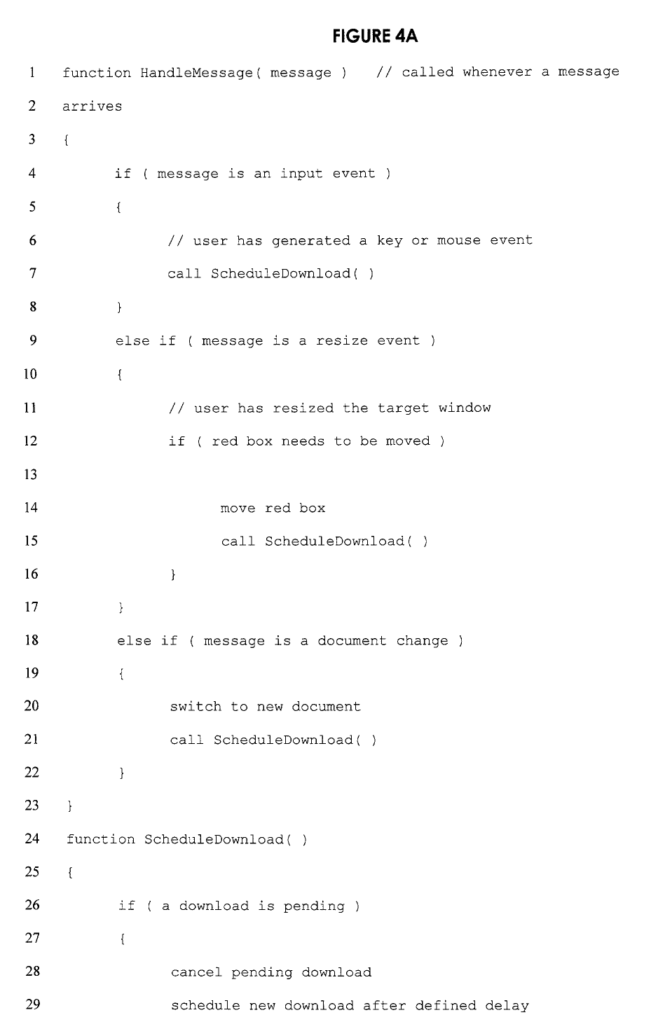

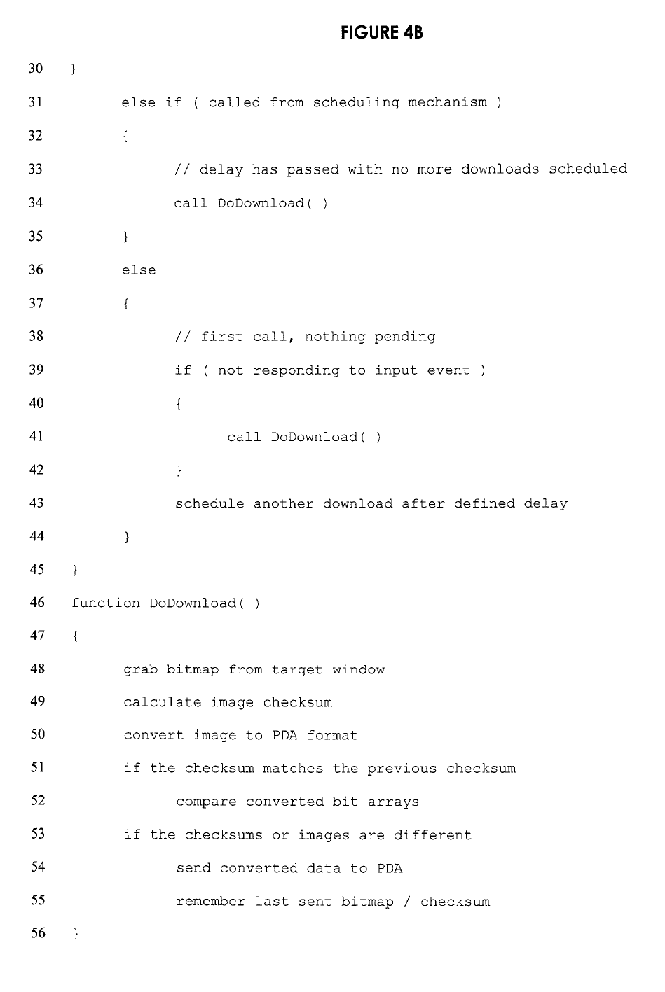

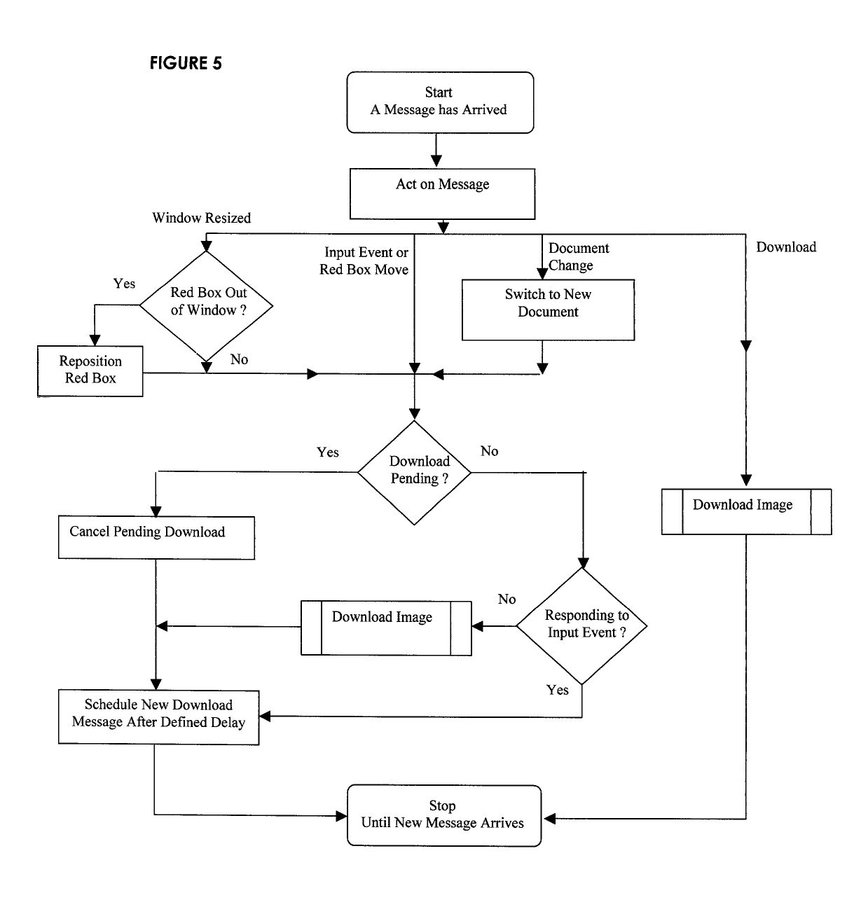

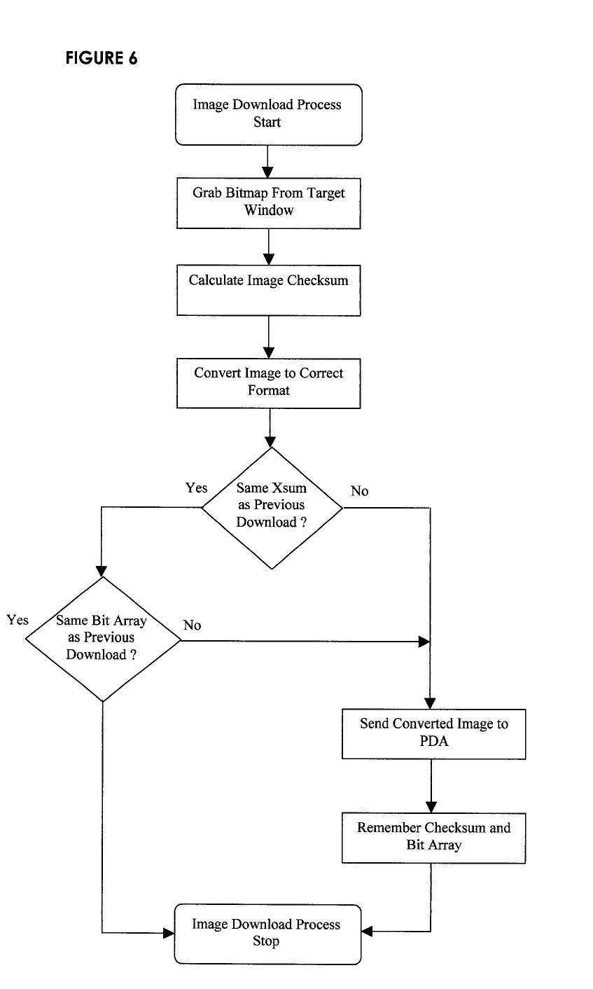

FIG. 1 shows a block diagram of the complete system for annotating general computer documents, and controlling the computer and application, using an annotation peripheral.

The annotation peripheral 10, of which portion is a peripheral communications module 20 which implements the protocols necessary to transmit and receive control and image data to and from the PC. A computer 30 includes a communications module 40, which implements the protocols necessary to transmit and receive control and image data to and from the annotation peripheral 10. The communication modules 20 and 40 can use any mutually agreed-to low-level protocols such as RS-232, 802.11 wireless Ethernet local area network (LAN), wired Ethernet LAN, or equivalent.

Annotation data, consisting of stylus location information, control information, navigational information, and attribute information, is transmitted from the annotation peripheral 10 via communication modules 20 and 40 and is received by the target interface module 60 and real-time rendering module 70. In the preferred embodiment, only sparse pixel coordinate data is communicated from the annotation peripheral 10, plus Start-of-Line (stylus-down) and End-of-Line (stylus-up) indicators, plus line attribute information, such that the minimum amount of data needs to be communicated in order to use the least communications channel bandwidth possible and conserve power, while still communicating a rich enough description of the annotation to appear naturalistic when rendered.

At the time the annotation data is received by a target interface module 60, a real-time rendering module 70 has received a set of display area coordinates of a cursor area 120 within an active document 110 from the target interface module 60, relative to the coordinate space of the computer screen. The real-time rendering module 70 converts stylus position annotation data from the coordinate space of the annotation peripheral 10 into the coordinate space of the user's display screen, and renders the incoming annotation data in near real-time on the computer display, according to Start-of-Line, End-of-Line, and line attribute information sent from the annotation peripheral, without regard to the inner workings of a target application 90.

At the same time, the target interface module 60 converts stylus location annotation data from the coordinate space of the annotation peripheral 10 into the coordinate space of the active document 110 in the target application 90, by accounting for the location of the cursor area 120 on the screen, the active document's 110 window location on the screen, and the mapping of the active document's 110 content within the coordinate system of the target application 90. There is a linear mapping between the coordinate spaces of the annotation peripheral 10 and the display of the active document 110. The mapping is determined by the size of the active document's 110 window, the position of the cursor area 110 within the display window, the size of the cursor area 120, the target application's 90 display zoom factor, the computer's display resolution, and the current offset into the active document 100 of the target application's 90 display window. In an enabling and preferred embodiment, these factors are queried to the operating system except where the offset of the active document 100 within its window is provided by an event hook module 80 for some modes of some applications, where it is more easily derived from the interception and analysis of events within the target application 90.

The target interface module 60 also buffers line attribute control commands as they are transmitted, and monitors the state of the stylus as being in either the stylus-down or stylus-up state, according to control data sent from the annotation peripheral 10. A stylus-down command causes the target interface module 60 to begin buffering stylus location data until a stylus-up command is received.

When a stylus-up command is received the target interface module 60 prepares the buffered stylus coordinate data and the currently defined line attribute data for transfer to the target application 90. The annotation data coordinate information is converted into the coordinate space of the target application 90 and is converted into the data structure format necessary to communicate it to the target application 90 via operating system and application facilities for application control, shown in FIG. 1 as the operating system application control interface 100. In an enabling embodiment, in any one of Microsoft Corporation's Microsoft Windows 95, Microsoft Windows 98, or Microsoft Windows NT operating systems, with the target application 90 being any one of Microsoft Word versions 8 or 9, Microsoft Excel version 9, or Microsoft Powerpoint versions 8 or 9, this is defined as conversion into a series of function calls to OLE Automation Interfaces which permit the system of the invention to cause the target application 90 to execute internal instructions corresponding to commands (e.g., draw a line of a certain thickness in a certain color at certain coordinates) which are normally performed manually through the traditional user interface or within the application under the application's control, under programmatic control of an external process (in this case the process running the software of the invention) instead. The conversion process in the preferred embodiment therefore consists not only of coordinate space transformation but also structuring of the annotation graphic data into a series of OLE Automation interface function calls, with function call arguments formatted appropriately, resulting in the invocation of functions of the target application 90 that support the inclusion of graphic data into its active document 110.

When the series of OLE Automation function calls are performed by the target interface module 60, the annotation data is converted internally to the target application 90 into internal data structures that represent graphic objects which are a close replication of the annotation data as drawn on the annotation peripheral 10, and which henceforth are managed by the target application 90 as an integral part of the Active Document 110.

The invention specifies use of an annotation peripheral 10 capable of displaying a section of the active document 110 directly on the surface being drawn upon. An area on the computer screen within the active document's 110 window is visibly indicated as the cursor area 120 where annotation of the document will take place. To support the functionality of displaying the screen contents within the cursor area 120 on the annotation peripheral 10, the event hook module 80 constantly monitors the behavior of the target application 90 and the user interface associated with it. The event hook module 80 informs the target interface module 60 of events (e.g. scrolling, document change, input events) occurring within the target application 90 which might result in the annotation peripheral 10 display requiring an update. When such an event occurs an update operation is scheduled.

When the update operation starts, the target interface module 60 obtains a copy of the bitmap data of the computer display area within the cursor area 120. A checksum calculation is performed on the contents of the bitmap data contained within the cursor area 120, and if in a sequence of two update operations the checksum results differ, a change of cursor area 120 contents has occurred and update of the annotation peripheral 10 takes place. The bitmap of the cursor area 120 contents is then transmitted to the annotation peripheral 10.

The invention calls for the ability for the annotation peripheral 10 to communicate navigation and control commands to the target application 90 via data that are interpreted by the target interface module 60 as control commands. In the preferred embodiment, this is done by tagging each data packet from the annotation peripheral 10 with a function code that identifies the nature of the packet.

When control packets are received by the target interface module 60 they are converted into an appropriate command format that can be transmitted to the target application 90 via the operating system application control interface 100, which in the case of the enabling preferred embodiment is the OLE Automation Interface. This permits the system of the invention to cause the target application 90 to execute internal instructions corresponding to commands (e.g. scroll window, pan document, zoom in, zoom out, as illustrative and not limiting examples) which are normally performed manually through the traditional user interface or within the application under the application's control, under programmatic control of an external process (in this case the process running the software of the invention) instead.

The invention specifies a navigational mode of display that permits navigation within the entire displayed area of the active document 110, in which the image of the entire window area of the active document 110 is obtained in the same manner in which the invention obtains the image of the contents of the cursor area 120 in normal operation, and is then transmitted and displayed on the annotation peripheral 10. A feature of the display so created is that the cursor area 120 is represented on the screen of the annotation peripheral 10. The stylus control which in normal operation is used to input annotation graphics is then used to move the representation of the cursor area 120 around on the display of the annotation peripheral 10 during which time the Cursor Area 120 is shown to move in the active document's 110 window area. Upon the user's indication, in the preferred embodiment this being a tap of the stylus on a button displayed on the screen of the annotation peripheral 10, the current location of the cursor area 120 becomes the new cursor area 120 within which annotation will recommence. The manner in which to use special control signals to switch to the navigational mode, and move the cursor area 120, will be obvious to one skilled in the art.

What is claimed is:

1. A computer-implemented method for a user to electronically annotate an electronic file, comprising:
a. providing a computer system having a computer display and an input device,
b. receiving through the input device a drawn line trace as input from the user;
c. rendering a plurality of pixels corresponding to the drawn line trace according to a pre-selected attribute; and
d. displaying the pixels on the computer display substantially simultaneously as the user enters the drawn line trace through the input device.

2. The method of claim 1, wherein the input device is a handheld computer peripheral device.

3. The method of claim 1, wherein the input device is the computer display.

4. The method of claim 1, wherein the input device is adapted to display selected portion of a screen data displayed on the computer display.

5. The method of claim 1, wherein the peripheral device is adapted to display all of the screen data displayed on the computer display.

6. The method of claim 1 further comprising interpolating the drawn line trace prior to rendering, wherein the peripheral device sends only a subset of information about the drawn line trace to the computer, such that the resulting pixels displayed on the computer display appear to be a continuous drawn line trace.

7. The method of claim 1 further comprising determining one or more attributes of the drawn line trace, said attributes comprising:
a. a thickness of the drawn line trace;
b. one or more shading characteristics of the drawn line trace;
c. one or more dithering characteristics of the drawn line trace;
d. a mode to erase previously drawn line trace; and
e. one or more colors of the drawn line trace.

8. The method of claim 1, where receiving the drawn line trace comprises receiving only an abstract representation of the drawn line trace.

9. The method of claim 8, wherein the abstract representation comprises one or more straight lines.

10. The method of claim 8, wherein the abstract representation comprises one or more rough-drawn straight lines.

11. The method of claim 8, wherein the abstract representation comprises one or more simple geometrical curves.

12. The method of claim 8, wherein the abstract representation comprises one or more complex geometrical curves.

13. The method of claim 8, wherein the abstract representation comprises one or more composite geometrical shapes.

14. The method of claim 8, wherein the abstract representation contains information to mimic in reproductive form the drawn line trace.

15. The method of claim 8, wherein the abstract representation comprises a signature of the user.

16. The method of claim 15, wherein the abstract representation comprises:
a. an abstract primitive of the drawn line trace; and one or more relevant attributes of the abstract primitive, sufficient to enable a reconstitution of the drawn line trace.

17. The method of claim 15, wherein the abstract representation further comprises:
a. an abstract primitive type of the drawn line trace;
b. a length of a locus of the drawn line trace;
c. an average width of a line comprising the drawn locus of the drawn line trace;
d. a color in formation of the drawn line trace ; and
e. a sketchiness information to indicate sketchy nature of the drawn line trace.

18. A computer program product stored on a computer-readable medium for interacting with a user inputting a drawn line trace, the product comprising instructions operable for causing a programmable processor to:
a. receive through an input device the drawn line trace as input from the user;
b. render a plurality of pixels corresponding to the drawn line trace according to a pre-selected attribute; and
c. display the pixels on a computer display substantially simultaneously as the user enters the drawn line trace through the input device.

19. A computer program, residing on a computer-readable medium, comprising instructions for causing a computer to:
a. receive through an input device the drawn line trace as input from the user;
b. render a plurality of pixels corresponding to the drawn line trace according to a pre-selected attribute; and
c. display the pixels on a computer display substantially simultaneously as the user enters the drawn line trace through the input device.

20. A computer system for a user to electronically annotate electronic files, comprising:
a. an input device for receiving the drawn line trace as input from the user;
b. a computer processor connected with the input device for rendering a plurality of pixels corresponding to the drawn line trace according to a pre-selected attribute; and
the computer display for displaying the pixels substantially simultaneously as the user enters the drawn line trace through the input device.
